(19) United States
(12) Patent Application Publication
(10) Pub. No.: US 2003/0222577 A1
(43) Pub. Date: Dec. 4, 2003

(54) Full color organic light-emitting display device

(75) Inventor: Tien-Rong Lu, Tainan (TW)

Correspondence Address: BACON & THOMAS, PLLC, 625 SLATERS LANE, FOURTH FLOOR, ALEXANDRIA, VA, 22314

(73) Assignee: RiTdisplay Corporation, Hsin Chu Industrial Park (TW)

(21) Appl. No.: 10/445,955

(22) Filed: May 28, 2003

(30) Foreign Application Priority Data
May 28, 2002 (TW) 91111361

(51) Int. Cl. H05B 33/00

(52) U.S. Cl. 313/504

(57) ABSTRACT

This invention relates to an organic light-emitting display (OLED) device comprising a substrate, a first electrode layer (cathode) mounted on one side of the substrate, a second electrode layer (anode) sandwiched between the substrate and the first electrode layer (cathode), at least one organic electroluminescent layer sandwiched between the first electrode layer (cathode) and the second electrode layer (anode), a color conversion layer of fluorescent powder sandwiched between the substrate and the second electrode layer (anode), and at least one filter layer sandwiched between the color conversion layer of fluorescent powder and the substrate; wherein said organic electroluminescent layer emits light in a wavelength bandwidth of blue light, and said color conversion layer of fluorescent power converts the light emitted from said organic electroluminescent layer into green, red or blue light. Also, the present invention relates to a process for fabricating the OLED device.

### BACKGROUND OF THE INVENTION

1. Field of the Invention

The present invention relates to a flat-panel display device, and more particularly, to an organic light-emitting display (OLED) device suitable for full color display.

2. Description of Related Art

There are two common technologies known in the prior full-color OLEDs, i.e., three primary color light emitting technology which uses an organic light-emitting material of three primary colors (i.e., red, green and blue) to separately serve as organic electroluminescent pixels, and color filtering technology which adopts only a white organic light-emitting material in combination with red, blue and green color filters to produce various colors.

The conventional three primary color light-emitting technology is shown FIG. 1, which is a schematic view of the conventional three primary color based technology. The three primary color based technology forms a plurality of anodes 102 over a transparent substrate 100, and then a red organic electroluminescent layer 110, a green organic electroluminescent layer 120 and a blue organic electroluminescent layer 130 are respectively formed on the anodes 102 by evaporation. A cathode 104 is subsequently formed on the organic electroluminescent layers 110, 120 and 130 by evaporation, an appropriate treatments are made. The three primary color based technology employs the characteristic of active luminescence inherent in the OLED to produce different colors. Hence, no additional color-tuning filter element is necessary. However, the technology of manufacturing the separate pixels emitting light of three primary colors is complex and involves many difficulties. For manufacturing a large-sized and full-colored OLED panel with high resolutions, an excellent and complex evaporation processing is required, especially for the mass production.

In addition, fine small-molecule red-light emitting organic material is indispensable. A reliable source of supply of such fine material is currently limited, however. Meanwhile, the luminescent efficiency of the light-emitting material of each of the three primary colors appears different. To ameliorate the uniformity of image display, a drive circuit to this end will be very complex. Also, in an attempt to harmonize the image display, difficulties in structural integration of films and driving of circuit occur.

The conventional technology of color change medium (CCM) is shown in FIG. 2, which is a schematic view of the conventional technology of CCM. The CCM based technology forms a printed color CCM 210 over a transparent substrate 200. Then another organic white-color conversion layer includes separate orange organic electroluminescent layer and blue organic electroluminescent layer. An orange organic electroluminescent layer 222 is formed over the color CCM 210. Then a blue organic electroluminescent layer 224 is formed over the orange organic electroluminescent layer 222. As the currents is applied for driving the blue organic electroluminescent layer 224 and the orange organic electroluminescent layer 222, the light from the blue organic electroluminescent layer 224 will mix with the light from the orange organic electroluminescent layer 222 and further converts into a white light. The color CCM based technology then converts the white light from the organic electroluminescent layer into various color by the assistance of the combination of blue, red and green color filters to display full color. The luminescent efficiency of the color CCM based technology is poor. However, the color of OLED device based on color CCM technology is not sharp and clear since the white light generated from the mixing of orange light and blue light is not very pure or homogeneous. Therefore, the OLED device based on color CCM technology cannot be applied for high resolution full-color display. The scope of application of the color CCM based technology is limited, and not suitable for mass production.

Moreover, another new full color organic light-emitting device has been proposed. This new full color organic light-emitting device utilizes an organic electroluminescent layer emitting ultraviolet light first. The ultraviolet light then radiates and excites another organic electroluminescent layers for converting ultraviolet radiation into the light of red, green and blue colors located at predetermined positions for producing a full-color effect. However, since the degradation effect on the organic electroluminescent layer of red, green and blue caused by ultraviolet is very strong, the lifetime of this full color organic light-emitting device is short. Besides, it is found that the ultraviolet light is greatly absorbed by other elements of this full color organic light-emitting device. Hence, the efficiency of the light conversion is low, too. Moreover, since some of the ultraviolet light leaks out from the active area of the OLED panel, it is harmful to human eyes, especially for a long time watching.

Therefore, there is a need for the commercial market to provide a new full color technology to avoid the above-mentioned processing problems. Also, the features of close uniformity of luminescent efficiency and high resolution are achieved, and can be applicable to large-sized full color OLED devices.

### SUMMARY OF THE INVENTION

Accordingly, it is a primary object of the present invention is to provide a full color OLED device to homogenize the luminescent efficiency of the pixels of various colors, reduce difference in luminescent efficiency between various colors, improve luminescent efficiency, enhance color resolution, and be applicable to large-sized displays.

A further object of the present invention is to provide a process for fabricating full color OLED devices to simplify the fabrication process without application of red organic electroluminescent layer, and enhance the purity of white light.

To attain the afore-mentioned objectives, and OLED device according to the present invention includes: a substrate; a first electrode layer (cathode) mounted on one side of said substrate; a second electrode layer (anode) sandwiched between said substrate and said first electrode layer (cathode); at least one organic electroluminescent layer sandwiched between said first electrode layer (cathode) and said second electrode layer (anode); and a color conversion layer of fluorescent powder sandwiched between said substrate and said second electrode layer (anode); wherein said organic electroluminescent layer emits light in a wavelength bandwidth of blue light, and said color conversion layer of fluorescent powder converts the light emitted from said organic electroluminescent layer into green, red or blue light.

A process for fabricating OLED devices according to the present invention comprises the following steps: forming at least one color conversion layer of fluorescent powder over a substrate; forming a second electrode layer (anode) over said color conversion layer of fluorescent powder; forming at least one organic electroluminescent layer over said second electrode layer (anode); and forming a first electrode layer (cathode) over the organic electroluminescent layer; wherein said organic electroluminescent layer emits light in a wavelength bandwidth of blue light, and said color conversion layer of fluorescent powder converts the light emitted from said organic electroluminescent layer into green, red or blue light.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view showing the conventional three primary color based technology of the full color OLEDs;

FIG. 2 is a schematic view showing the conventional technology of CCM of the full color OLEDs; and

FIG. 3 is schematic view of an OLED device according to a preferred embodiment of the present invention.

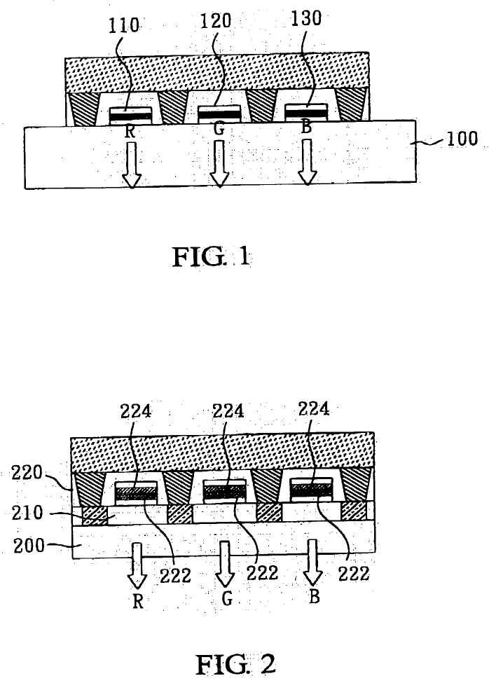

### DETAILED DESCRIPTION OF THE PREFERRED EMBODIMENT

The material of the substrate of the OLED device according to the present invention is selected from transparent material, and preferably is soda-lime glass, borophosphosciliate glass, plastic or silicon wafer. The first electrode can be made of any conventional material. Preferably, the first electrode is made of InSnO₃, SnO₂, In₂O₃ with doped ZnO, CdSnO or Ti. The second electrode can be made of any conventional material. Preferably, the second electrode is made of MgAg, Al, diamond, quasi-diamond or Ca. The OLED device according to the present invention can be either a single-layered or multi-layered structure of an organic electroluminescent material. The multi-layered organic electroluminescent structure may selectively include a hole injection layer, a hole transport layer, a light-emission layer, an electron transport layer or an electron injection layer. A dark-color frame of light-absorption matrix for shading light may be selectively provided between the filters or the filter and the substrate to lessen the luminescent interference caused by ambient lights and increase sharpness of display image at the edge of the pixels. The shape of the first electrodes and the second electrodes of the present invention can be any conventional shape of conductive electrodes. Preferably, the first electrodes or the second electrodes of the present invention are in a shape of stripes. The arrangement of the first electrodes and the second electrodes are not limited. Preferably, the first electrodes cross the second electrodes.

In addition, an overcoating layer is optionally coated on the surface of the color conversion layer. Preferably, the overcoating is sandwiched between the second electrodes and the color conversion layer for protecting the color conversion layer.

The color conversion layer of the present invention is a thin film composed of a fluorescent powder and a binding polymer to convert light emitted from the organic electroluminescent layer by excitation through an electric current into various colors. The color conversion layer is constructed by a fluorescent powder capable of absorbing ultraviolet or blue light, especially the near ultraviolet or blue light with short wavelength. The fluorescent powder (or phosphors) layer is formed by wet coating or by dry deposition. The fluorescent powder is preferably selected to be endurable to highly intensive light and capable of converting a blue, ultraviolet or white organic light into a red, green, or blue light. The fluorescent powder is used based on the wavelength of light emitted from the organic electroluminescent layer. If the organic electroluminescent layer emits ultraviolet, light, the fluorescent powder used for the color conversion layer is preferably a composition capable of converting the emitted ultraviolet light into red, green or blue. If the organic electroluminescent layer emits blue light, the fluorescent powder used for the color conversion layer is preferably a composition capable of converting the emitted blue light into red or green. Preferably, the binding polymer is transparent epoxy, polyimide, urea resin, silicone or transparent inorganic adhesive. The transparent inorganic adhesive preferably is SiO₂ or TiO₂. It is preferable for the transparent epoxy to be used in the wet coating processing while the transparent adhesive is preferably used in the dry deposition processing. The mixture ratio of the fluorescent powder and the binding polymer is adjustable in accordance with the luminescent efficiency of various colors to balance the luminescent efficiency. The distribution of the fluorescent powder in the color conversion layer can be controlled by arranging the structure of the color conversion layer as well as the temperature, viscosity, crystal structure and grain size used for forming the fluorescent powder. The OLED device can further comprise an overcoating layer sandwiched between the second electrode (anode) and the color conversion layer, wherein the second electrode layer (anode) and the substrate sandwich the overcoating layer to protect the color conversion layer. The material of the overcoating layer of the present invention is not specifically limited, and preferably is transparent epoxy, polyimide, urea resin, silicone or transparent inorganic adhesive. The transparent inorganic adhesive preferably is SiO₂ or TiO₂. It is preferable for the transparent epoxy to be used in the wet coating processing while the transparent adhesive is preferably used in the dry deposition processing.

The fluorescent powder used in the present invention is not specifically defined, and preferably is yttrium aluminum oxide (YAG) fluorescent powder with doped rare-earth element. Because part of yttrium will be substituted by the rare-earth element in the crystal lattice, Y_{2.9}R_{0.1}Al₅O₁₂ (R is rare-earth element) is formed. YAG is a transparent material of thermal stability, and capable of emitting light of different colors after doping different rare-earth elements. For example, The Y₃Al₅O₁₂ doped with Tb emits green light, and the Y₃Al₅O₁₂ doped with Ce emits yellow light.

The color conversion layer can be prepared by either wet processing or dry processing. A wet processing technique is to weigh the required quantity of the fluorescent powder to be blended directly, and then appropriate solvent and epoxy are added to the fluorescent powder, whereafter the powder, solvent and epoxy are mixed together. Another wet processing technique is to mix the fluorescent powder with solvent at the atomic scale by the sol-gel process or co-precipitation method, and then, mix them with epoxy. Thereafter, the mixture is applied to the overcoating layer or light-emitting panel by spin coating or printing, and then, is baked to remove the solvent and water.

The dry processing technique is to weigh the required quantity of the fluorescent powder to be blended directly or mixed with a solvent at the atomic scale by the sol-gel process or co-precipitation method, and then, the mixture is blended with transparent adhesive such as SiO₂ or TiO₂. It is necessary to consider the deposition rate for different color fluorescent powders in deposition. Further, an overcoating layer can be selectively formed to cover the color conversion structure.

It is preferable that the OLED according to the present invention be formed as a display panel having an array of a plurality of pixels emitting red, green and blue light to display an image, and also, the OLED according to the present invention can be a monochromatic display panel having an array of pixels emitting light, if so desired. The OLED panel fabricated according to the present invention can be applied to any environments or apparatus for displaying images, graphics, characters and text, and preferably, to the display panels of televisions, computers, printers, monitors, vehicles, to the display of signal machines, communication apparatus, telephones, lamp equipment, headlights, interactive electronic books, micro-displays, fishing devices, personal digital assistants (PDA), game means, aircraft equipment and head mounted displays.

Embodiment 1 OLED

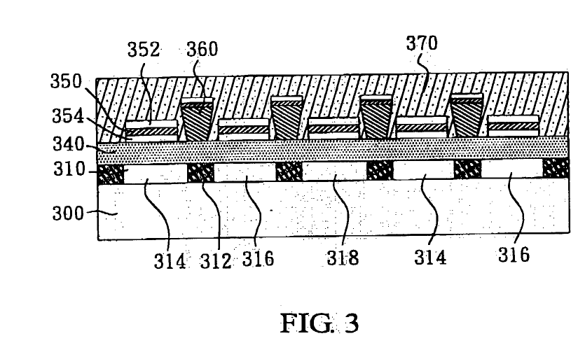

FIG. 3 is a schematic view of the OLED device according to a preferred embodiment of the present invention. The OLED device of the present invention is passive matrix type, comprising a substrate 300, a cathode (a first electrode layer) 352, and anode (a second electrode layer) 354, a blue organic electroluminescent layer 350, a plurality of color conversion pads of fluorescent powder 310, an overcoating layer 340, a dark-color frame of light-absorption matrix 312, and a cathode passivation 370. The color conversion pads of fluorescent powder 310 includes red conversion pads of fluorescent powder 314, green conversion pads of fluorescent powder 316, and transparent or blue conversion pads of fluorescent powder 318. In the process of manufacturing of OLED device of the present invention, the dark-color frame of a light-absorption matrix 312 and a plurality of color conversion pads 310 such as red conversion pads of fluorescent powder 314, green conversion pads of fluorescent powder 316, and transparent or blue conversion pads of fluorescent powder 318 are first formed over the substrate 300. Hence, each of the color conversion pads 310 corresponds to a pixel. The pixel as herein referred is constructed by the cathode (first electrode layer) 352, the anode (second electrode layer) 354 and the organic electroluminescent layer 350. Although the organic electroluminescent layer is of a single-layer structure as illustrated hereinto, it can also be of multi-layer structure. The dark-color frame of the light-absorption matrix 312 is a black light-shading shadow mask used to shade diffusion light at the edge of the pixels. The dark-color frame of light-absorption matrix 312 surrounds the edge of the pixels to define the size of the pixels. The overcoating layer 340 is formed over the black frame of the light absorption matrix 312 and the color conversion pads 310 to protect the black light-absorption shadow mask and the color conversion pads. In the present preferred embodiment, an overcoating layer 340 is formed over the black light-absorption shadow mask 312 and the color conversion pads 310. The color conversion pads of the fluorescent powder 310 is a thin film consisting of a fluorescent powder and a binding polymer to convert the blue light emitted by excitation of the organic electroluminescent layer through an electric current into red, green or blue light. A transparent indium tin oxide (ITO) layer 354 in the form of stripes is provided over the overcoating 340 and above the color conversion pads of the fluorescent powder 310. The stripe-shaped ITO layers 354 can be separated by isolating walls of photoresist parallel to each other to isolate a cathode substance formed between the pixels. The organic electroluminescent layer 350 is formed over the ITO layer 354 by evaporation or sputtering to emit light in a certain wavelength range. In this preferred embodiment, the electroluminescent layer 350 emits light in a wavelength range of blue after excitation by an electric current.

The fabrication of the OLED device of the preferred embodiment is started by preparing a fluorescent powder for forming a layer of fluorescent powder over the substrate first. The fluorescent powder is prepared by co-precipitation with triethylamine oxalate. The process for preparation of the fluorescent powder is briefly described below.

### EXAMPLE 1

Fluorescent Powder Production

YAG fluorescent powder is produced by co-precipitation with triethylamine oxalate. R (NO₃)₃ (Wherein R is La—Ce—Pr—Sm—Tb—Ho—Tm or Yb), Y(NO₃)₃ and Al(NO₃)₃ are mixed under stoichiometric ratio, and sufficiently dissolved in 25 ml of deionized water. Thereafter, 15 ml of triethylamine and 10 ml of oxalic and (1.2 moles) are added to the above-mentioned mixture and processed at a pH of approximately 10.22, thereby obtaining white precipitated gels in the solution. Subsequently, the liquid mixture is agitated for several minutes, and then purified with a filtering process by air-extraction. After filtering, the white precipitated gels are baked in an oven for about twelve hours, and then, the baked white precipitated gels are taken out. Thereafter, they are placed in a furnace. Initially, the furnace is maintained at a temperature of 300+ C. for an hour, and then, the temperature is increased to 500° C. and is maintained for another one hour, and finally, the temperature is increased to 100° C. and maintained for another 24 hours. After cooling, the fluorescent powder with doped rare-earth element is obtained. As a result, the fluorescent powder is characterized by having a short period of residual fluorescence for about 120 nano-seconds, and is therefore applicable to be described as a component requiring fast response time.

The composition of the fluorescent powder prepared by this example in accordance with different light-emitting sources is shown in table 1.

TABLE 1

| Wavelength of light-emitting source | Composition of fluorescent powder |
|---|---|
| 470 nm (Blue light) | YAG:Ce³⁺(Yellow) |
| 420-473 nm (Blue | YBO₃:Ce³⁺, Tb³⁺(Green)/ |
| light/Ultraviolet light) | SrGa₂S₄:Eu²⁺(Blue)/ |
| | Y₂O₂S:Eu³⁺, Bi³⁺(Red) |
| 370 nm (Ultraviolet light) | Ca₈ Mg (SiO₄)₄ Cl₂:Eu²⁺, |
| | Mn²⁺(Green) 20-50%/ |
| | Y₂O₃:EU³⁺,Bi³⁺(Red)40-80%/ |
| | Ca₅(PO₄)₃Cl:Eu²⁺(B1ue) or |
| | BaMg₂Al₁₆O₂₇:Eu²⁺(Blue) 5-25% |
| 460 nm (Blue light) | SrGa2O4:Eu2+ (Green)/ |
| | CaS:Eu (Red) |

The color conversion layer is prepared subsequent to completion of the preparation of the fluorescent powder layer. The process for preparation of the color conversion layer is briefly describe below.

### EXAMPLE 2

Color Conversion Layer Production—Wet Process

The proportion of the fluorescent material is dosed in accordance with the principle of balancing the different luminescent efficiencies of the fluorescent material caused by three primary colors with reference to predetermined wavelength (e.g. blue light wavelength) of the emitted light in the spectrum Then, the fluorescent materials are blended with epoxy resin at atomic scale through sol-gel process.

### EXAMPLE 3

Color Conversion Layer Production—Dry Process

In the dry process, the quantities of the fluorescent material and transparent medium are weighted, and then, sufficiently blended to form a target. The target may be alternatively formed by the sol-gel process or co-precipitation method. A planed fluorescence color conversion layer is formed on the panel of organic light-emitting device by evaporation, sputtering or ion-beam deposition, wherein the proportion of the fluorescent material is dosed in accordance with the principle of balancing the difference in deposition rate of different fluorescent materials, to convert the light emitted at a shorter wavelength (e.g. blue light) in the spectrum into light of a longer wavelength in the spectrum (e.g. red light).

The dark-color frame of light-absorption matrix 312 is formed on the substrate 300 through vapor deposition. Then the color conversion layer of the fluorescent powder 310 of various colors (i.e. the red color conversion pads 314, the green color conversion pads 316, and the transparent or the blue color conversion pads 318) is formed by deposition. After completing preparation for the color conversion layer (or pads), thereafter, an overcoating 340 is coated onto the color conversion layer 310 by deposition. Then, an anode layer 354 (transparent electrode of ITO material) is formed over overcoating layer 340 by sputtering. The anode layer 354 is patterned by photolithography to form a plurality of transparent electrodes in the form of parallel stripes over the substrate. After sufficiently rinsing, a photoresist layer of a uniform thickness is formed over the substrate by spin-coating the composition of positive chemical amplification photoresist. Thereafter, the substrate coated on the positive chemical amplification photoresist composition is pre-baked in an oven. Then, the substrate is exposed in a development machine by means of stripe-patterned shadow masks. Further, the substrate is subject to post-exposure baking treatment, and simultaneously, the surface of the photoresist layer is treated under the atmosphere full of tetramethyl ammonium hydroxide. After development, a plurality of transparent ITO electrodes in the form of parallel stripes with run perpendicular to the parallel stripe-shaped photoresist layer are formed over the substrate. The cross-section of the photoresist layer in the form of parallel stripes shows a top as a reverse trapezoid with a thickness of 0.8 μm. The line width of the stripe-shaped photoresist layer is 0.18 μm. Then, an organic electroluminescent layer 340 is formed over the anode layer 344 by evaporation. The formation of the organic electroluminescent layer 340 is made by using the stripe-shaped isolation body layer having a top as a reverse trapezoid as shadow masks, to form a layer of CuPc (copper phthalocyanine) with a thickness of 250 angstroms in the gaps between the parallel shadow masks by vacuum evaporation, and subsequently forming a layer of NPB(4,4′-bis[N-(1-naphthyl)-N-phenyl-amino]-biphenyl) with a thickness of 500 angstroms by evaporation, and then forming a layer of BA-1 (Bis (2-methyl-8-quinolinolato) aluminum(III)-μ-oxo-bis (2-methyl-8-quinolinolato) aluminum (III)) with a thickness of 500 angstroms by evaporation, and further forming a layer of LiF with a thickness of 15 angstroms. A cathode layer of aluminum 352 is formed over the organic electroluminescent layer 352 is made by vacuum evaporation to have a thickness of 1000 angstroms. Thus, an OLED component is formed. Finally, a passivation layer such as aromatic polyimide, parylene or teflon copolymer is deposited over the cathode layer 352.

The device is turned on by providing an electric current through the cathode 352 and the anode 354, and the organic electroluminescent layer 350 is driven to emit blue light. The blue light sheds light on the color conversion layer of fluorescent powder 310 such as the red color conversion pads 314, the green color conversion pads 316, and the transparent and the blue color conversion pads 318 and is converted into red, green, and blue light separately.

The OLED device of the present invention is the first OLED which uses monochromatic electroluminescent medium as the light source and converts the emitting light from the monochromatic electroluminescent medium into various color through the assistance of fluorescent powder. Therefore, the shortage of the reliable source of electroluminescent medium can be overcome, especially for the shortage of the reliable source of red color materials. On the other hand, since the coating or the deposition of the fluorescent powders is matured and developed well, the recipe of the compositions of the color conversion layer and the formation technique of the color conversion layer are available on market. Therefore, the OLED of the present invention can be mass produced very easily. Also, the present invention increases yields of fabrication, and is very suitable for use in the large-sized panels. Besides, since the brightness, the luminescence efficiency, or even the uniformity of the color conversion layer can tuned by adjusting the recipe of the composition of the fluorescent powder, the brightness and the uniformity of the displayed color for full color application can be improved. In addition, the light of the OLED of the present invention is not mixed by complementary colored light but is provided by the primary colored light. The purity of the displayed color is high and homogeneous. Moreover, the present invention adopts the mature techniques of fluorescent materials and color filters to used in the field of the OLED, and thus, can accelerate the commercial availability of the full color OLEDs.

In addition, the organic electroluminescent component of the present invention uses blue light of a shorter wavelength to excite the fluorescent powder for emission without causing the spectrum of a specific orientation. Hence, the present invention can provide uniform radiation of a wide bandwidth in the spectrum, and is particularly suitable for being a light source used for scanners or displays.

Although the present invention has been explained in relation to its preferred embodiment, it is to be understood that many other possible modifications and variations can be made without departing from the spirit and scope of the invention as hereinafter claimed.

What is claimed is:

1. An organic light-emitting display device, comprising
a substrate;
a first electrode layer (cathode) mounted on one side of said substrate;
a second electrode layer (anode) sandwiched between said substrate and said first electrode layer (cathode);
at least one organic electroluminescent layer sandwiched between said first electrode layer (cathode) and said second electrode layer (anode); and
a color conversion layer of fluorescent powder sandwiched between said substrate of said second electrode layer (anode);
wherein said organic electroluminescent layer emits light in a wavelength bandwidth of blue light, and said color conversion layer of fluorescent powder converts the light emitted from said organic electroluminescent layer into green, red or blue light.

2. The organic light-emitting display device as claimed in claim 1, further comprising an overcoating layer sandwiched between said second electrode (anode) and said color conversion layer of fluorescent powder for protecting said color conversion layer of fluorescent powder.

3. The organic light-emitting display device as claimed in claim 1, further comprising a passivation layer formed over said first electrode layer (cathode) to protect said first electrode layer (cathode); and said passivation layer is aromatic polyimide, parylene, or teflon copolymer.

4. The organic light-emitting display device as claimed in claim 1, further comprising at least one dark-color frame of a light-absorption matrix mounted at edges of the pixels of said color conversion layer of fluorescent powder to avoid leakage of light.

5. The organic light-emitting display device as claimed in claim 1, wherein said second electrode layer (anode) is transparent.

6. The organic light-emitting display device as claimed in claim 1, wherein said second electrode layer (anode) is made of indium tin oxide (ITO).

7. The organic light-emitting display device as claimed in claim 2, wherein said overcoating layer is made of transparent epoxy, polyimide, urea resin, silicon or transparent inorganic adhesive SiO₂, or transparent inorganic adhesive TiO₂.

8. The organic light-emitting display device as claimed in claim 1, wherein said organic electroluminescent layer is made of polymeric organic electroluminescent material or small-molecule organic electroluminescent material to produce blue or ultraviolet light to excite said color conversion layer of fluorescent powder to emit green light or red light.

9. The organic light-emitting display device as claimed in claim 1, wherein said color conversion layer of fluorescent powder is a composition or inorganic fluorescent powder.

10. The organic light-emitting display device as claimed in claim 1, wherein said first electrodes layer (cathode) is in a form of plural stripes and said second electrode layer (anode) is in a form of plural stripes, and said first electrode layer (cathode) intersects said second electrode layer (anode).

11. A process for fabricating organic light-emitting display devices, comprising the following steps:
forming at least one color conversion layer of fluorescent powder over a substrate;
forming a second electrode layer (anode) over said color conversion layer of fluorescent powder;
forming at least one organic electroluminescent layer over said second electrode layer (anode); and
forming a first electrode layer (cathode) over the organic electroluminescent layer;
wherein said organic electroluminescent layer emits light in a wavelength bandwidth of blue light, and said color conversion layer of fluorescent powder converts the light emitted from said organic electroluminescent layer into green, red or blue light.

12. The process as claimed in claim 11, further comprising forming a transparent overcoating layer over said color conversion layer of fluorescent powder after forming said color conversion layer of fluorescent powder, and said transparent overcoating layer is sandwiched between said color conversion layer of fluorescent powder and said second electrode for protecting said color conversion layer of fluorescent powder.

13. The process as claimed in claim 11, further comprising forming a dark-color frame of a light-absorption matrix over said substrate after forming said color conversion layer of fluorescent powder, wherein said dark-color frame of said light-absorption matrix is mounted at edges of the pixels of said color conversion layer of fluorescent powder to avoid leakage of light.

14. The process as claimed in claim 12, further comprising forming a dark-color frame of a light-absorption matrix over said substrate before forming said overcoating layer, wherein said dark-color frame of said light-absorption matrix is mounted at edges of the pixels of said color conversion layer of fluorescent powder to avoid leakage of light.

15. The process as claimed in claim 11, wherein said color conversion layer of fluorescent powder is formed by deposition.

16. The process as claimed in claim 11, wherein said second electrode layer (anode) is made of indium tin oxide (ITO).

17. The process as claimed in claim 12, wherein said overcoating layer is made of transparent epoxy, polyimide, urea resin, silicone or transparent inorganic adhesive SiO₂, or transparent inorganic adhesive TiO₂.

18. The process as claimed in claim 11, wherein said organic electroluminescent layer is made of polymeric organic electroluminescent material or small-molecule organic electroluminescent material.

19. The process as claimed in claim 11, wherein said color conversion layer of fluorescent powder is a composition of inorganic fluorescent powder.

20. The process as claimed in claim 11, wherein said first electrode layer (cathode) is in a form of plural stripes and said second electrode layer (anode) is in a form of plural stripes, and said first electrode layer (cathode) intersects said second electrode layer (anode).
